(19) United States
(12) Patent Application Publication
(10) Pub. No.: US 2007/0120343 A1
(43) Pub. Date: May 31, 2007

(54) LIGHTED FOOTREST FOR MOTORCYCLE

(76) Inventor: Wendell Lee Spence, Boyne City, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/561,647

(22) Filed: Nov. 20, 2006

Related U.S. Application Data
(60) Provisional application No. 60/739,384, filed on Nov. 25, 2005.

(51) Int. Cl. B62J 25/00

(52) U.S. Cl. 280/291

(57) ABSTRACT

An illuminated footrest for a motorcycle includes a base having an apertured flange on one end for connection to a mounting bracket, the base also including a cavity, at least one side opening and an end opening. A side lens and an end lens cover the at least one side opening and the end opening, respectively. An illumination source is positioned in the cavity and illuminates the side lens and the end lens. In one aspect, the apertured flange is replaced with an adapter for mounting the footrest on different motorcycle footrest mounting brackets.

This application claims priority from under 35 U.S.C. § 119(e) from provisional patent application Ser. No. 60/739,384, filed Nov. 25, 2005, entitled: “MOTORCYCLE FOOTPEG WITH INTERNAL AND EXTERNAL LED LIGHTS WITH ALTERNATE MOUNTING ADAPTOR,” the entire contents of which are incorporated herein in their entirety.

### BACKGROUND

The present invention relates to lighted footrests and foot pegs for motorcycles.

Various lighted footrests and foot pegs with reflectors are available in the prior art. However, they shine light only in a single direction, such as only in a downward direction. It is desirable to provide a lighted footrest with additional lighting capability. It is also desirable to provide side-directed lighting on motorcycles, making the motorcycles more visible from a side and hence providing increased safety. Additionally, it is noted that the visual “signature” and appearance of a motorcycle is often very important to bike owners.

Thus, a system having the aforementioned advantages and solving the aforementioned problems is desired.

### SUMMARY OF THE PRESENT INVENTION

In one aspect of the present invention, an illuminated footrest for a motorcycle includes a base having an apertured flange on one end for connection to a mounting bracket, the base also including a cavity, at least one side opening and an end opening. A side lens and an end lens cover the at least one side opening and the end opening, respectively. An illumination source is positioned in the cavity and illuminates the side lens and the end lens.

In another aspect of the present invention, an illuminated footrest for a motorcycle includes a base having a configured aperture in one end, the base including a cavity and at least one opening extending from the cavity. A lens covers the at least one opening. An illumination source is positioned in the cavity for illuminating the lens. A pair of adapters is provided, each with a first portion shaped to matably engage the configured aperture and a second portion shaped to engage a different standard motorcycle footrest mount for mounting the footrest to a particular style motorcycle.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a footrest embodying the present invention.

FIG. 2 is an exploded view of the footrest in FIG. 1.

FIG. 2A is an exploded view of a modified footrest similar to FIG. 2.

FIGS. 2B and 2C are exploded side views of a second modified footrest.

### DETAILED DESCRIPTION OF PREFERRED EMBODIMENTS

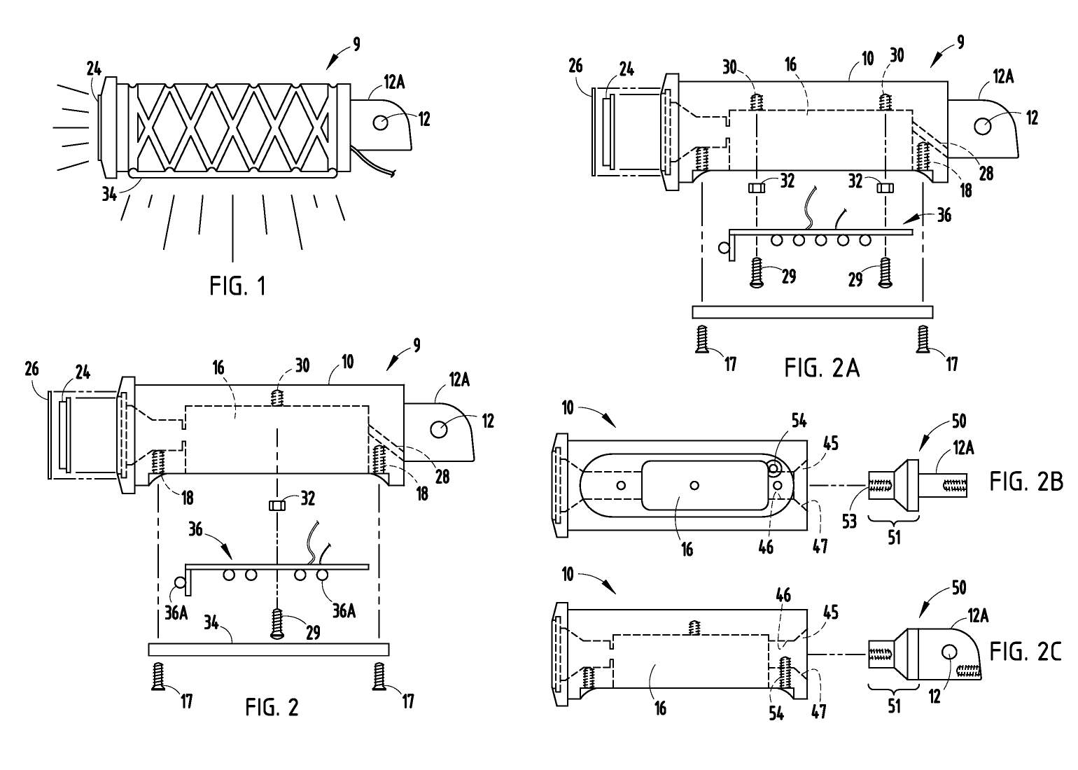

The present footrest 9 (also called “foot peg”) of the instant invention attaches with a standard mounting bracket to motorcycles, and is manufactured the same as standard footrests so the protruding end will fit a standard mounting bracket. The footrest 9 (FIG. 1) includes a base 10 having crisscross grooves on its exterior for non-slip support to a user's boot. The illustrated footrest 9 has a cylindrical cross-sectional shape, but it is contemplated that the present inventive concepts will also work with other shaped footrests, such as foot rests having a rectangular or square cross section. A mounting bracket hole 12 is formed in a coaxially-extending mounting flange 12A at one end for pivotal mounting to a motorcycle. The footrest 9 includes an end lens 24 at the other end and a side lens 34, and includes internal LEDs to light up the lenses 24 and 34, creating a distinctive and useful pattern of light around the motorcycle.

The base 10 includes a cavity 16 that allows a lighted circuit board 36 to be mounted inside with a ring-shaped spacer 32, a screw 29 and a threaded hole 30. The illustrated space 32 is made of metal and acts as an electrical ground. Cavity 16 provides an opening through an end of the base 10, with the opening defining a first annular recess for receiving the round end lens 24 and a spiral retaining ring 26 (also called a snap ring). The end lens 24 is recessed into the end of the base 10 in a flush and partially protected position. The cavity 16 further provides an opening in a side of the base 10, with the opening defining a pocket for lens 34, and threaded holes 18 for attachment screws 17. The lens 34 fits into the pocket so that it is substantially flush with (or slightly raised from) a continuing exterior surface of the base 10. A hole 28 extends from cavity 16 to an area adjacent the base of flange 12A for an electrical wire extending from the lighted circuit board 36 to a power source on the motorcycle. The illustrated circuit board 36 includes a plurality of LEDs 36A for lighting the side lens 34, and at least one LED 36A facing toward an end of the footrest 9 for lighting the end lens 24. It is noted that the end-facing LED can be mounted to a perpendicularly extending portion of the circuit board 36, or that the end-facing LED can be mounted on a flat portion of the circuit board 36 but oriented to shine toward the end opening.

Notably, the base 10 can be modified (see FIG. 2A) to include additional or other attachment structure. For example, the base in FIG. 2A includes a pair of the threaded holes 18 for receiving a pair of attachment screws 17 and a pair of the spacers 32. Also, it is noted that the spacer can be made of any suitable material, or can be formed as an integral protruding surface on the base 10 in the cavity 16.

It is contemplated that the base can be further modified (FIGS. 2B-2C) by replacing the apertured integral flange on the end of the base 10 (which is adapted for a Harley Davidson motorcycle) with an adapter 50. In FIG. 2B, the end of the base 10A is cut away to include a hole 45 with a first portion 46 of constant diameter size and a second frustoconically-shaped portion 47. The adapter 50 includes a stem 51 that matably engages the portions 46 and 47, and further includes a mounting flange 12A with mounting bracket hole 12 and structure for mounting to a motorcycle. Notably, the flange 12A can be replaced with any hole and structure required for mounting to different motorcycles. An end of the stem 51 includes a threaded hole 53, and an axial screw (not shown) is threaded from the inside of the cavity 16 into the threaded hole 53 to secure the adapter 50 to the base 10A. A set screw hole 54 is formed in the base 10A for receiving a set screw to secure the axial screw in position, and to secure the adapter 50 stably and durably to the footrest. Alternatively, it is contemplated that the screw hole 54 can be positioned so that its screw (or a friction-retained stud) engages a recess in a side of the portion 46, thus locking the adapter 50 in its installed position.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. An illuminated footrest for a motorcycle comprising:
a base including an apertured flange on one end for connection to a mounting bracket, the base including a cavity, at least one side opening and an end opening;
a side lens and an end lens covering the at least one side opening and the end opening, respectively; and
an illumination source is positioned in the cavity for illuminating the side lens and the end lens.

2. The footrest defined in claim 1, wherein the illumination source includes at least one LED facing toward the end lens and at least one LED facing toward the at least one side lens.

3. The footrest defined in claim 1, wherein the side lens is positioned flush with an exterior surface of the base.

4. The footrest defined in claim 1, wherein the end lens is positioned flush with an exterior end surface of the base.

5. The footrest defined in claim 1, including a circuit board supporting the illumination source.

6. The footrest defined in claim 5, including at least one screw securing the circuit board to the base inside the cavity.

7. An illuminated footrest for a motorcycle comprising:
a base including a configured aperture in one end, the base including a cavity and at least one opening extending from the cavity;
a lens covering the at least one opening;
an illumination source positioned in the cavity for illuminating the lens; and
a pair of adapters each with a first portion shaped to matably engage the configured aperture and a second portion shaped to engage a different standard motorcycle footrest mount for mounting the footrest to a particular style motorcycle.

8. An illuminated footrest for a motorcycle comprising:
a base including an apertured flange on one end for connection to a mounting bracket, the base including a cavity and an end opening;
an end lens covering the end opening; and
an illumination source is positioned in the cavity for illuminating the end lens.

9. The footrest defined in claim 8, wherein the illumination source includes at least one LED facing toward the end lens.

10. The footrest defined in claim 8, wherein the end lens is positioned flush with an exterior end surface of the base.

11. The footrest defined in claim 8, including a circuit board supporting the illumination source.

12. The footrest defined in claim 11, including at least one screw securing the circuit board to the base inside the cavity.
